(19) United States
(12) Patent Application Publication
(10) Pub. No.: US 2025/0133497 A1
(43) Pub. Date: Apr. 24, 2025

(54) METHOD AND APPARATUS FOR UPLINK TRANSMISSION BY USER EQUIPMENT HAVING WAKE-UP RECEIVER IN WIRELESS COMMUNICATION SYSTEM

(71) Applicant: Samsung Electronics Co., Ltd., Gyeonggi-do (KR)

(72) Inventors: Seunghoon CHOI, Gyeonggi-do (KR); Hyewon YANG, Gyeonggi-do (KR); Jaewon LEE, Gyeonggi-do (KR)

(21) Appl. No.: 18/917,311

(22) Filed: Oct. 16, 2024

(30) Foreign Application Priority Data
Oct. 18, 2023 (KR) 10-2023-0139527

(51) Int. Cl. H04W 52/02; H04W 76/28

(52) U.S. Cl. CPC H04W 52/0229; H04W 76/28

(57) ABSTRACT

The disclosure relates to a fifth generation (5G) or sixth generation (6G) communication system for supporting a higher data transmission rate. A method performed by a UE includes receiving, from a BS, configuration information associated with a WUS, monitoring the WUS based on the configuration information, in case that the WUS is received from the BS, determining whether the detected WUS triggers activation of an MR, and determining whether to transmit an uplink signal based on whether the detected WUS triggers the activation of the MR.

### CROSS-REFERENCE TO RELATED APPLICATION(S)

This application is based on and claims priority under 35 U.S.C. § 119 to Korean Patent Application No. 10-2023-0139527, which was filed in the Korean Intellectual Property Office on Oct. 18, 2023, the entire disclosure of which is incorporated herein by reference.

### BACKGROUND

### 1. Field

The disclosure relates generally to a wireless communication system, and more particularly, to a method and an apparatus for enabling a user equipment (UE) having a wake-up receiver to transmit an uplink (UL) signal/channel in a wireless communication system.

### 2. Description of Related Art

Fifth generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) including 28 GHz and 39 GHz. In addition, it has been considered to implement 6G mobile communication technologies (referred to as beyond 5G systems) in terahertz (THz) bands (for example, 95 GHz to 3 THz bands) to achieve transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying 2-step RA channel (2-step RACH) procedures for NR. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

To process mobile data traffic which has recently increased exponentially, initial standards of NR access technology or 5G systems which are next-generation communication systems after long term evolution (LTE) (or evolved universal terrestrial radio access (E-UTRA)) and LTE-advanced (LTE-A) (or E-UTRA evolution) have been completed. While legacy mobile communication systems have focused on conventional voice/data communication, 5G systems aim to satisfy various services and requirements, such as an eMBB service for improving legacy voice/data communication, URLLC service, and MTC service supporting massive machine-to-machine communication.

The system transmission bandwidth per single carrier of legacy LTE and LTE-A is limited to a maximum of 20 megahertz (MHz), but 5G systems aim to provide super-fast data services up to multiple gigabits per second (Gbps) by using super-broad bandwidths far wider than the same. Accordingly, 5G systems consider super-high-frequency bands ranging from multiple GHz to a maximum of 100 GHz, in which it is relatively simple to secure super-broad-bandwidth frequencies, as candidate frequencies. Additionally, it is possible to secure broad-bandwidth frequencies for 5G systems through frequency rearrangement or allocation among frequency bands ranging from hundreds of MHz to multiple GHz used in legacy mobile communication systems.

Radio waves in super-high frequency bands have millimeter-level wavelengths and thus are also referred to as mmWaves. However, the pathloss of radio waves in super-high frequency bands increases in proportion to the frequency band, thereby reducing the coverage of the mobile communication systems.

To overcome the shortcoming of coverage reduction in super-high frequency bands, a beamforming technology is applied such that the distance reached by radio waves is increased by concentrating the energy radiated by the radio waves at a specific target point by using multiple antennas. For example, signals to which the beamforming technology is applied have a smaller beam width, and radiated energy is concentrated within the smaller beam width, thereby increasing the distance reached by radio waves. The beamforming technology may be applied to each of the transmission and reception ends. In addition to the increased coverage, the beamforming technology is also advantageous in that interference is reduced in regions in directions other than the beamforming direction. Appropriate operations of the beamforming technology require a method for accurately measuring transmitted/received beams and sending feedback. The beamforming technology may be applied to a control channel or a data channel having one-to-one correspondence between a UE and a gNB. In addition, the beamforming technology may also be applied to a control channel and a data channel for transmitting a common signal transmitted from a gNB to multiple UEs in the system, such as a synchronization signal, a physical broadcast channel (PBCH), and system information, to increase the coverage. When the beamforming technology is applied to a common signal, a beam sweeping technology is additionally applied such that the signal is transmitted after changing the beam direction, thereby ensuring that the common signal can reach a UE existing at a specific location inside the cell.

As another requirement of 5G systems, an ultra-low latency service is required such that the transmission delay between the transmission and reception ends is about 1 ms.

The transmission time interval (TTI) is the basic time unit for performing scheduling, and legacy LTE and LTE-A have a TTI of 1 millisecond (ms), which corresponds to the length of one subframe. For example, the short TTI, on which 5G systems are based to meet the requirement regarding the ultra-low latency service, may be 0.5 ms, 0.25 ms, 0.125 ms, or the like, which is shorter than a legacy LTE and LTE-A.

To reduce the transmission delay, there is a need for frame structure design based on a shorter TTI than in LTE and LTE-A.

As described above, signal transmission/reception in super-broad bandwidths ranging from tens or hundreds of MHz or multiple GHz may be supported to accomplish a super-fast data service at multiple Gbps in 5G systems. Signal transmission/reception in super-broad bandwidths may be supported through a single component carrier (CC) or through a carrier aggregation (CA) technology which combines multiple CCs. If the mobile communication operator fails to secure frequencies in a bandwidth enough to provide a super-fast data service by using a single CC, the CA technology combines respective CCs having a relatively small bandwidth size such that the total sum of frequency bandwidths is increased, consequently enabling a super-fast data service.

5G systems are designed and developed in consideration of all of various use cases. Besides the standby time, reliability, and availability, the UE's energy efficiency is critical in 5G systems. 5G UEs need to be charged on a weekly or daily basis according to the individuals' time of use. In general, 5G UEs consume tens of milliwatts (mW) in radio resource control (RRC)_IDLE/RRC_INACTIVE states and consume hundreds of mW in RRC_CONNECTED states. Design for extending the battery life may be an indispensable element not only for better user experiences, but also for improved energy efficiency. Energy efficiency may be more important to UEs having no continuous energy supply (for example, UEs using small rechargeable and single coin cell batteries). Among 5G use cases, sensors and actuators are arranged for monitoring, measurement, charging, and the like on a wide scale. In general, batteries for sensors or actuators cannot be recharged, and may be expected to last at least a few years. However, the charge for batteries in wearable devices such as smartwatches, rings, eHealth-related devices, and medical monitoring devices tends not to last more than a few hours, depending on the time of use.

A 5G UE's power consumption depends on the configured length (e.g., the paging cycle) of wakeup periods, and an extended discontinuous reception (eDRX) cycle having a large value may be used to satisfy battery lifetime requirements. However, the eDRX scheme maintains a long battery lifetime based on a long standby time, and thus is inappropriate for a service having a short standby time. For example, in use for fire sensing and extinguishing, it is within 1-2 seconds from the timepoint at which a fire is detected by a sensor that fire shutters need to be closed, and sprinklers need to be activated by actuators. In this case, the standby time may be critical, and a long eDRX cycle as in existing cases cannot satisfy latency requirements and may thus be inappropriate for such a case.

Thus, there is a need for a scheme regarding signal reception by a UE having a wake-up receiver to address excessive power consumption by the UE and to achieve a high degree of energy efficiency of the UE.

### SUMMARY

The disclosure has been made to address at least the above-mentioned problems and/or disadvantages and to provide at least the advantages described below.

Accordingly, an aspect of the disclosure is to provide a method and an apparatus for UL transmission by a UE having a wake-up receiver in a wireless communication system.

An aspect of the disclosure is to provide a method and apparatus for addressing excessive power consumption by a UE in a wireless communication system and accomplishing a high degree of energy efficiency.

An aspect of the disclosure is to define UE operations necessary for when DRX is configured such that a UE having a wake-up receiver discontinuously monitors a physical downlink (DL) control channel (PDCCH) in an RRC_CONNECTED state, and the wake-up signal is received through the wake-up receiver.

In accordance with an aspect of the disclosure, a method performed by a UE includes receiving, from a base station (BS), configuration information associated with a wake-up signal (WUS), monitoring the WUS based on the configuration information, in case that the WUS is received from the BS, determining whether the detected WUS triggers activation of a main radio (MR), and determining whether to transmit an uplink signal based on whether the detected WUS triggers the activation of the MR.

In accordance with an aspect of the disclosure, a method performed by a BS includes transmitting, to a UE, configuration information associated with a wake-up signal (WUS), and transmitting, to the UE, the WUS, wherein it is determined whether an uplink signal is received from the UE based on whether the WUS triggers activation of a main radio (MR).

In accordance with an aspect of the disclosure, a UE includes a transceiver, and a controller coupled with the transceiver and configured to receive, from a BS, configuration information associated with a WUS, monitor the WUS based on the configuration information, in case that the WUS is received from the BS, determine whether the detected WUS triggers activation of an MR, and determine whether to transmit an uplink signal based on the whether the detected WUS triggers the activation of the MR.

In accordance with an aspect of the disclosure, a BS includes a transceiver, and a controller coupled with the transceiver and configured to transmit, to a UE, configuration information associated with a WUS, and transmit, to the UE, the WUS, wherein it is determined whether an uplink signal is received from the UE based on whether the WUS triggers activation of an MR.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment;

FIG. 2 illustrates a beam sweeping operation and a time domain mapping structure of a synchronization signal according to an embodiment;

FIG. 3 illustrates a flow of signals for performing a random access (RA) according to an embodiment;

FIG. 4 illustrates a flow of signals used by a UE to report UE capability information to a gNB according to an embodiment;

FIG. 5 illustrates state transitions of a gNB and a UE and the state of the UE based on the gNB state, according to an embodiment;

FIG. 6 illustrates when a UE having a wake-up receiver transmits UL signals, according to an embodiment;

FIG. 7 illustrates a method in which a UE having a wake-up receiver transmits UL signals, according to an embodiment;

FIG. 8 illustrates a method in which a gNB receives UL signals, according to an embodiment;

FIG. 9 illustrates a structure of a base station according to an embodiment; and

FIG. 10 illustrates a structure of a UE according to an embodiment.

### DETAILED DESCRIPTION

Embodiments of the disclosure will be described in detail with reference to the accompanying drawings.

In the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Embodiments of the disclosure enable a constitution of the disclosure to be complete and are provided to fully inform the scope of the disclosure to those of ordinary skill in the art to which the disclosure pertains.

Throughout the specification, the same or like reference signs indicate the same or like elements.

Herein, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

In the following description, terms for identifying access nodes and referring to network entities, messages, interfaces between network entities, various identification information, and the like are illustratively used for the sake of descriptive convenience. Therefore, the disclosure is not limited by the terms as described below, and other terms referring to subjects having equivalent technical meanings may also be used.

The terms physical channel and signal may be interchangeably used with the term data or control signal. For example, the term physical DL shared channel (PDSCH) refers to a physical channel over which data is transmitted, but the PDSCH may also be used to refer to the data. For example, the expression “transmit ting a physical channel” may be construed as having the same meaning as the expression “transmitting data or a signal over a physical channel”.

Herein, upper signaling refers to a signal transfer scheme from a base station to a terminal via a DL data channel of a physical layer, or from a terminal to a base station via a UL data channel of a physical layer. The upper signaling may also be understood as RRC signaling or a media access control (MAC) control element (CE).

The disclosure will be described using terms used in some communication standards (e.g., the 3rd generation partnership project (3GPP)), but these are for illustrative purposes only. The disclosure may be easily applied to other communication systems through modifications. In addition, a “terminal” may refer to not only cellular phones, smartphones, IoT devices, and sensors, but also other wireless communication devices.

Herein, a base station is an entity that allocates resources to terminals, and may be at least one of a gNode B, a gNB, an eNode B, an eNB, a Node B, a base station (BS), a wireless access unit, a base station controller, and a node on a network. A terminal may include a UE, a mobile station (MS), a cellular phone, a smartphone, a computer, or a multimedia system capable of performing a communication function. Examples of the base station and the terminal are not limited to those mentioned above. Systems based on long term evolution (LTE), LTE-advanced (LTE-A), or NR may be described by way of example, but the disclosure may also be applied to other communication systems having similar technical backgrounds or channel types. In addition, based on determinations by those skilled in the art, the disclosure may also be applied to other communication systems through some modifications without significantly departing from the scope of the disclosure.

As used herein, the UL may refer to a radio link via which a UE transmits data or control signals to a base station, and the DL may refer to a radio link via which the base station transmits data or control signals to the UE.

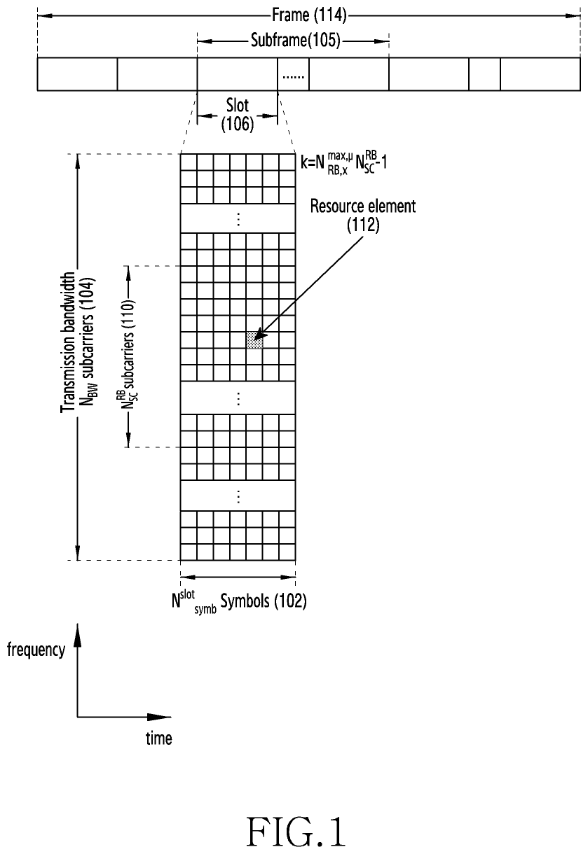

FIG. 1 illustrates the basic structure of a time-frequency resource domain in a wireless communication system according to an embodiment. Specifically, FIG. 1 illustrates the basic structure of a time-frequency resource domain which is a radio resource domain used to transmit data or control channels in a 5G system.

Referring to FIG. 1, the horizontal axis in FIG. 1 denotes the time domain, and the vertical axis denotes the frequency domain. The minimum transmission unit in the time domain of the wireless communication system is an orthogonal frequency division multiplexing (OFDM) symbol, a group of N_{symb}^{slot} symbols 102 may constitute one slot 106, and a group of Nₛₗₒₜ^{subframe} slots may constitute one subframe 105. The subframe's length may be 1.0 ms, and a group of ten subframes may constitute a 10 ms frame 114. The minimum transmission unit in the frequency domain is a subcarrier, and a total of N_{BW} subcarriers 104 may constitute the entire system transmission bandwidth.

The basic unit of a resource in the time-frequency domain is a resource element (RE) 112, which may be described by an OFDM symbol index and a subcarrier index. A resource block (RB) or a physical resource block (PRB) may be defined by N_{sc}^{RB} consecutive subcarriers 110 in the frequency domain. In the 5G system, N_{sc}^{RB}=12, and the data rate may increase in proportion to the number of RBs scheduled for a UE.

In wireless communication systems, a gNB may map data at the RB level, and may generally schedule RBs constituting one slot with regard to a specific UE. For example, the basic time unit to perform scheduling in 5G systems may be a slot, and the basic frequency unit to perform scheduling may be an RB.

The number (N_{symb}^{slot}) of OFDM symbols is determined according to the length of a cyclic prefix (CP) which is added to each symbol to prevent interference between symbols. For example, if a normal CP is applied, N_{symb}^{slot}=14, and if an extended CP is applied, N_{symb}^{slot}=12. The extended CP is applied to a system having a larger radio-wave transmission distance than the normal CP, thereby maintaining orthogonality between symbols. In the normal CP, the ratio between the CP length and the symbol length may be maintained constant such that overhead caused by the CP is maintained constant regardless of the subcarrier spacing. For example, the symbol length may increase if the subcarrier spacing decreases, thereby increasing the CP length. In contrast, the symbol length may decrease if the subcarrier spacing increases, thereby decreasing the CP length. The symbol length and the CP length may be inversely proportional to the subcarrier spacing.

To satisfy various services and requirements in wireless communication systems, various frame structures may be supported by adjusting the subcarrier spacing. For example, in terms of the operating frequency band, the larger the subcarrier spacing, the more advantageous for restoration of phase noise in high-frequency bands. In terms of the transmission time, if the subcarrier spacing increases, the symbol length in the time domain decreases. The resulting decreased slot length is advantageous for supporting an ultra-low latency service such as URLLC. In terms of the cell size, the larger the CP length, the larger the cell is that can be supported. Therefore, the smaller the subcarrier spacing, the larger the cell is that can be supported. As used herein, a cell refers to a region covered by one gNB in connection with mobile communication.

The subcarrier spacing, the CP length, and the like correspond to information indispensable to OFDM transmission/reception, and a gNB and a UE need to recognize the subcarrier spacing, the CP length, and the like as mutually common values such that efficient transmission/reception is possible.

Table 1 below describes the relationship between the subcarrier spacing configuration (μ), the subcarrier spacing (Δf), and the CP length supported in 5G systems.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, |
| | | Extended |
| 3 | 120 | Normal |
| 4 | 240 | Normal |

Table 2 below enumerates the number (N_{symb}^{slot}) of slots per one slot, the number (Nₛₗₒₜ^{frame,μ}) of slots per one frame, and the number (Nₛₗₒₜ^{subframe,μ}) of slots per one subframe, with slot regard to each subcarrier spacing configuration (μ), in a normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 below enumerates the number (N_{symb}^{slot}) of slots per one slot, the number (Nₛₗₒₜ^{frame,μ}) of slots per one frame, and the number (Nₛₗₒₜ^{subframe,μ}) of slots per one subframe, with regard to each subcarrier spacing configuration (μ), in an extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

Since the introduction of 5G systems, coexistence with legacy LTE and/or LTE-A (hereinafter, referred to as LTE/LTE-A) or dual mode operation has been expected. Accordingly, legacy LTE/LTE-A may provide stable system operations to UEs, and 5G systems may provide improved services to UEs. Therefore, the frame structure of 5G systems needs to include at least the frame structure of LTE/LTE-A or an essential parameter set (subcarrier spacing=15 kilohertz (kHz)).

For example, a comparison between a frame structure having a subcarrier spacing configuration μ=0 (hereinafter, frame structure A) and a frame structure having a subcarrier spacing configuration μ=1 (hereinafter, frame structure B) shows that, compared with frame structure A, frame structure B has double the subcarrier spacing and RB size and half the slot length and symbol length. In frame structure B, two slots may constitute one subframe, and 20 subframes may constitute one frame.

To generalize the framed structure of 5G systems, the subcarrier spacing, the CP length, the slot length, and the like (essential parameter set) are integer multiples with each other with regard to each frame structure, thereby providing a high degree of extendibility. In addition, a subframe having a fixed length of 1 ms may be defined to represent a reference time unit unrelated to the frame structure.

The frame structure may be applied according to various scenarios. In terms of the cell size, the larger the CP length, the larger the cell is that can be supported. Therefore, frame structure A can support larger cells than frame structure B. In terms of the operating frequency band, the larger the subcarrier spacing, the more advantageous for restoration of phase noise in high-frequency bands. Therefore, frame structure B can support higher operating frequencies than frame structure A. In terms of the service, the smaller the slot length (basic time unit of scheduling), the more advantageous for supporting an ultra-low latency service, such as URLLC. Therefore, frame structure B may be more appropriate for the URLLC service than frame structure A.

In an initial access step in which a UE initially accesses a system, the UE may perform DL time and frequency domain synchronization and acquire a cell identifier (ID) from a synchronization signal, transmitted by a base station, through a cell search. In addition, the UE may receive a PBCH by using the acquired cell ID and acquire a master information block (MIB) as mandatory system information from the PBCH. Additionally, the UE may receive system information (system information block (SIB)) transmitted by the base station to acquire cell-common transmission and reception-related control information. The cell-common transmission and reception-related control information may include RA-related control information, paging-related control information, common control information for various physical channels, etc.

A synchronization signal serves as a reference for a cell search, and for each frequency band, a subcarrier spacing may be applied adaptively to a channel environment, such as phase noise. For a data channel or a control channel, to support various services as described above, a subcarrier spacing may be applied adaptively depending on a service type.

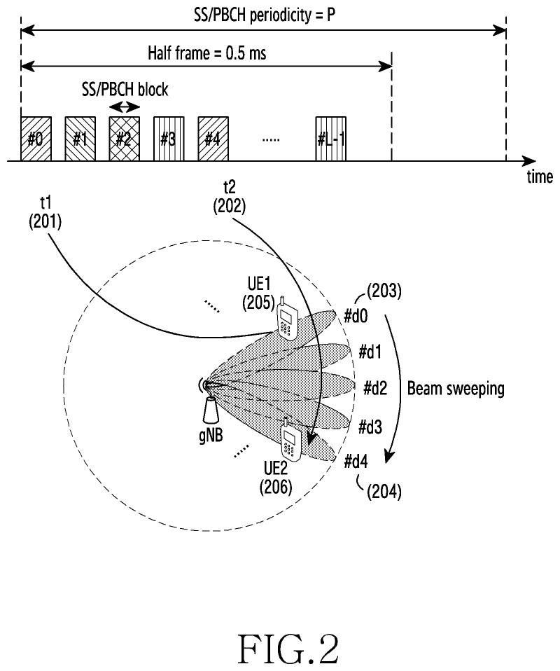

FIG. 2 illustrates a beam sweeping operation and a time domain mapping structure of a synchronization signal according to an embodiment.

For description purposes, the following elements may be defined in advance.

A primary synchronization signal (PSS) serves as a reference for DL time/frequency synchronization, and provides a part of cell ID information.

A secondary synchronization signal (SSS) serves as a reference for DL time/frequency synchronization, and may provide the other part of the cell ID information. Additionally, the SSS may serve as a reference signal for PBCH demodulation of a PBCH.

A PBCH may provide a MIB which is mandatory system information required for transmission and reception of a data channel and a control channel of a terminal. The mandatory system information may include search space-related control information indicating radio resource mapping information of a control channel, scheduling control information for a separate data channel for transmission of system information, a system frame number (SFN) which is a frame unit index that serves as a timing reference, and other information.

A synchronization signal/PBCH block (SS/PBCH block) or SSB may be configured by N OFDM symbols and may include a combination of a PSS, an SSS, a PBCH, etc. For a system to which a beam sweeping technology is applied, an SS/PBCH block may be a minimum unit to which beam sweeping is applied. In the 5G system, N=4 may be satisfied. A base station may transmit up to a maximum of L SS/PBCH blocks, and the L SS/PBCH blocks may be mapped within a half frame (0.5 ms). The L SS/PBCH blocks may be periodically repeated at predetermined periods P. The base station may inform a UE of period P via signaling. If there is no separate signaling of period P, the UE may apply a previously agreed default value.

Referring to FIG. 2, it is shown when beam sweeping is applied in units of SS/PBCH blocks over time. UE 1 205 may receive an SS/PBCH block by means of a beam emitted in direction #d0 203 by beamforming applied to SS/PBCH block #0 at time point t1 201, and UE 2 206 may receive an SS/PBCH block by a beam emitted in direction #d4 204 by beamforming applied to SS/PBCH block #4 at time point t2 202. The UE may acquire, from the base station, an optimal synchronization signal via a beam emitted in the direction where the UE is located. For example, it may be difficult for UE 1 205 to acquire time/frequency synchronization and mandatory system information from the SS/PBCH block through the beam emitted in direction #d4 far away from the location of UE 1.

In addition to the initial access procedure, to determine whether the radio link quality of a current cell is maintained at a certain level or higher, the UE may also receive the SS/PBCH block. During a handover procedure in which the UE moves access from the current cell to an adjacent cell, the UE may receive an SS/PBCH block of the adjacent cell to determine the radio link quality of the adjacent cell and acquire time/frequency synchronization with the adjacent cell.

After acquiring a MIB and system information from the base station through the initial access procedure, the UE may perform a RA procedure to switch a link to the base station to an RRC_CONNECTED state. Upon completing the RA procedure, the UE switches to a connected state in which one-to-one communication between the base station and the UE is possible.

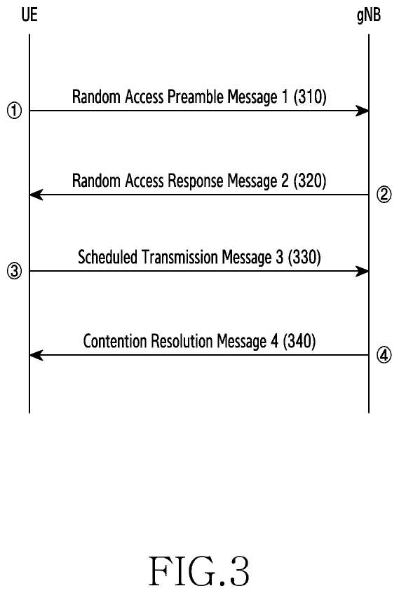

FIG. 3 illustrates a flow of signals for performing an RA according to an embodiment.

Referring to FIG. 3, in step 310, the UE may transmit an RA preamble to the gNB. The RA preamble is the first message transmitted by the UE in the RA procedure, and thus may be referred to as message 1. The gNB may measure the transmission delay value between the UE and the gNB from the RA preamble and may make UL synchronization. The UE may then arbitrarily select the RA preamble to be used, from a RA preamble set given by system information in advance. The initial transmission power of the RA preamble may be determined by the pathloss between the gNB and the UE, measured by the UE. The UE may also determine the transmission beam direction of the RA preamble from a synchronization signal received from the gNB and then transmit the RA preamble.

In step 320, the gNB may transmit an RA response (RAR) (or message 2) regarding the RA preamble received in step 310. The gNB may transmit a UL transmission timing adjustment command to the UE, based on a transmission delay value measured from the RA preamble. The gNB may transmit a power control command and a UL resource to be used by the UE, as scheduling information, to the UE. The scheduling information transmitted by the gNB may include control information regarding the UE's UL transmission beam.

If the UE fails to receive an RAR (or message 2) which is scheduling information regarding message 3 from the gNB within a predetermined time in step 320, the UE may perform step 310 again. When performing step 310 again, the UE may transmit the RA preamble after increasing the transmission power of the UE by a predetermined step (power ramping), thereby increasing the probability that the gNB will receive the RA preamble.

In step 330, the UE may transmit UL data (message 3) including the UE's ID to the gNB by using the UL resource allocated to the UE in step 320. The UE may transmit UL data including the UE's ID to the gNB through a physical UL shared channel (PUSCH). The transmission timing of the PUSCH for transmitting message 3 may follow the timing control command received from the gNB in step 320. The transmission power of the PUSCH for transmitting message 3 may be determined in consideration of a power control command received from the gNB in step 320 and the RA preamble's power ramping value. The PUSCH for transmitting message 3 may refer to the first UL data signal transmitted to the gNB by the UE, after transmission of the RA preamble by the UE.

In step 340, upon determining that the UE has performed a RA without contention with other UEs, the gNB may transmit data, i.e., a contention resolution message (message 4) including the ID of the UE which has transmitted UL data in 330 to the UE. Upon receiving the signal transmitted by the gNB in step 340 from the gNB, the UE may determine that the RA has succeeded. The UE may transmit hybrid automatic repeat request acknowledgement (HARQ-ACK) information to the gNB through a physical UL control channel (PUCCH) to indicate whether or not message 4 has been received successfully.

If the gNB fails to receive a data signal from the UE due to contention between the data transmitted by the UE in step 330 and data from another UE, the gNB may discontinue transmitting data to the UE. If the UE fails to receive data transmitted from the gNB in step 340 within a predetermined time, the UE may determine that the RA procedure has failed and may return to step 310.

Upon successfully completing the RA procedure, the UE may be switched to a connected state (or RRC_CONNECTED state), and one-to-one communication between the gNB and the UE may become possible. The gNB may receive UE capability information reported by the UE in the connected state (or RRC_CONNECTED state) and may adjust the scheduling with reference to the UE capability information from the UE. The UE may inform the gNB whether the UE itself supports a specific function or not, the maximum allowed value of the function supported by the UE, and the like through the UE capability information. Therefore, UE capability information reported to the gNB by each UE may have a different value with regard to each UE.

As an example, the UE may report UE capability information including at least one of the following pieces of control information to the gNB.
Control information regarding the frequency band supported by the UE
Control information regarding the channel bandwidth supported by the UE
Control information regarding the maximum modulation scheme supported by the UE
Control information regarding the maximum number of beams supported by the UE
Control information regarding the maximum number of layers supported by the UE
Control information regarding the CSI reporting supported by the UE
Control information regarding whether the UE supports frequency hopping
Control information regarding the bandwidth when CA is supported
Control information regarding whether cross carrier scheduling is supported when CA is supported

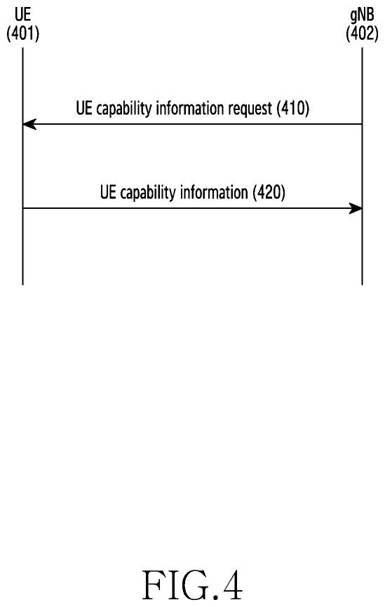

FIG. 4 illustrates a flow of signals used by a UE to report UE capability information to a gNB according to an embodiment.

Referring to FIG. 4, in step 410, the gNB 402 may transmit a UE capability information request message to the UE 401.

In step 420, the UE 401 may transmit UE capability information to the gNB, based on the UE capability information request of the gNB 402. The UE 401 may transmit UE capability information to the gNB 402 regardless of the UE capability information request of the gNB 402.

Based on the process in which UE capability information is transmitted/received, the UE connected to the gNB may conduct one-to-one communication with the gNB in the RRC_CONNECTED state. The UE in the RRC_CONNECTED state may monitor the PDCCH. If no discontinuous reception (DRX) is configured by the gNB, the UE's MAC entity may continuously monitor the PDCCH. If DRX is configured by the gNB for the UE's MAC entity through an upper-level signal, the UE's MAC entity may discontinuously monitor the PDCCH by using a DRX operation with regard to all activated serving cells. The UE may receive DRX operation-related parameters (including at least one of DRX cycle, drx-onDuration Timer, drx-InactivityTimer, or drx-SlotOffset, for example) from the gNB through an upper-level signal, and may discontinuously monitor the PDCCH, based on the parameters.

Herein, the description that the UE in the RRC_CONNECTED state monitors the PDCCH by DRX may also be expressed as a CONNECTED-DRX (C-DRX) operation is performed, or C-DRX is performed.

The DRX-configured UE may be configured through an upper-level signal so as to receive an indication regarding whether PDCCH monitoring is to be performed in drx-onDuration Timer which will arrive soon, through DCI format 2_6 (or DCP (downlink control protocol)). In connection with receiving the DCI format 2_6, DCI format 2_6 has been introduced to reduce power consumed by the UE while periodically monitoring the PDCCH at each C-DRX cycle. The UE may monitor or receive DCI format 2_6 prior to arrival of drx-onDuration Timer during the C-DRX cycle. If the UE has received an indication regarding a start/no start of the drx-onDurationTimer which will arrive soon, through a specific bit field in DCI format 2_6, and if the drx-onDurationTimer has not started, the UE may not perform PDCCH monitoring during the drx-onDurationTimer, thereby reducing UE power consumption. The UE may receive information regarding the resource for receiving the DCI format 2_6, the search space, the payload size, and the like through an upper-level signal-based configuration.

The UE in the RRC_CONNECTED state or the UE's MAC entity may receive DL data regardless of whether the PDCCH is monitored in the serving cell in the DRX group and may transmit aperiodic CSI and aperiodic SRS transmitted in the PUSCH when configured by HARQ feedback/upper-level signal or indicated by the PDCCH. Unlike the UL signal which directly affects DL data reception as in the HARQ feedback, or which is transmitted aperiodically as in the aperiodic CSI or aperiodic SRS, UL signals which are transmitted periodically, or which have a lower priority than the above-mentioned UL signal, restrictions may be placed such that UL transmission is performed only during a PDCCH monitoring time. As an example, if the MAC entity of the UE in the RRC_CONNECTED state is not in an active time during one FODM symbol, that is, if it is not a PDCCH monitoring time inside drx-onDurationTimer or drx-Inactivity Timer, the UE's MAC entity may not transmit periodic SRS and semi-persistent SRS configured by an upper-level signal, and may not report CSI transmitted in the PUCCH configured by an upper-level signal and semi-persistent CSI configured to be transmitted in the PUSCH, to the gNB. To be more specific,
If DCP monitoring has been configured for an active BWP, if the current symbol n has occurred inside the drx-onDurationTimer interval, and if drx-onDurationTimer related to the current DRX cycle has not started,
   If it is determined that no MAC entity is within the active time in consideration of grants/assignments/DRX Command MAC CE/Long DRX Command MAC CE received prior to 4 ms of symbol n and a transmitted scheduling request (SR), and if no configuration has been made by upper-level signal allowCSI-SRS-Tx-MulticastDRX-Active or cfr-ConfigMulticast for any active BWP of the serving cell,
      Periodic SRS and semi-persistent SRS, configured by an upper-level signal, are not transmitted to the gNB.
      Semi-persistent SRS configured to be transmitted in the PUSCH by an upper-level signal is not reported to the gNB.
      If upper-level signal ps-TransmitPeriodicL1-RSRP is not configured as true, periodic CSI which is L1-RSRP configured to be transmitted in the PUCCH by an upper-level signal is not reported to the gNB.
      If upper-level signal ps-TransmitOtherPeriodicCSI is not configured as true, periodic CSI other than L1-RSRP configured to be transmitted in the PUCCH by an upper-level signal is not reported to the gNB.
In other cases,
   If it is determined that the DRX group is not within the active time in consideration of grants/assignments scheduled in the serving cell of the DRX group received prior to 4 ms in current symbol n, and received DRX Command MAC CE/Long DRX Command MAC CE and transmitted SR, and if no configuration has been made by upper-level signal allowCSI-SRS-Tx-MulticastDRX-Active or cfr-ConfigMulticast for any active BWP of the serving cell,
      Periodic SRS and semi-persistent SRS, configured by an upper-level signal in the DRX group, are not transmitted to the gNB.
      Semi-persistent SRS configured to be transmitted in the PUSCH in the DRX group is not reported to the gNB.
      CSI configured to be transmitted in the PUSCH by an upper-level signal in the DRX group is not reported to the gNB.

Alternatively, if a CSI mask is configured for a UE by an upper-level signal, the UE may be further limited to transmit the UL signals (periodic SRS, semi-persistent SRS, CSI on PUCCH, semi-persistent CSI on PUSCH) only during a time within drx-onDurationTimer. To be more specific,
If CSI masking (csi-Mask) is configured by an upper-level signal,
   If drx-onDurationTimer of the DRX group does not operate in consideration of grants/assignments scheduled in the serving cell of the DRX group received prior to 4 ms in current symbol n, and received DRX Command MAC CE/Long DRX Command MAC CE, in the current symbol n, and if no configuration has been made by upper-level signal allowCSI-SRS-Tx-MulticastDRX-Active or cfr-ConfigMulticast for any active BWP of the serving cell,
      CSI configured to be transmitted in the PUSCH by an upper-level signal in the DRX group is not reported to the gNB.

If DRX is configured by an upper-level signal, an active time for the DRX group's serving cell may include the following time:
Time for which drx-onDurationTimer or drx-Inactivity Timer configured for the DRX group is running.
Time for which an SR is sent in the PUCCH and is pending.

The UE may transmit the SRS or CSI only during the active time or time within drx-onDuration Timer such that resources configured for the SRS or CSI during other times can be allocated to other UEs, and the gNB's resource utilization can be maximized.

In contrast to the RRC_CONNECTED state, a UE having no connection may be in an RRC_IDLE state, and the UE in the RRC_IDLE state may perform processes as follows:

Performing a UE-specific DRX cycle configured by the upper layer. The description that the UE in the RRC_IDLE state performs a DRX cycle may also be expressed as the UE performs an IDLE-DRX (I-DRX) operation, or the same performs I-DRX.
Receiving a paging message from the core network
Acquiring system information
A measurement operation related to the serving cell (or the cell on which the same is camping) and cell selection/reselection
A measurement operation related to a peripheral cell and cell reselection
Receiving a paging early indication (PEI)

The UE may measure the SS-RSRP and SS-RSRP levels at least for each M1*N1 DRX cycle with regard to the serving cell (or the cell on which the UE is camping) and may evaluate the cell selection determination standard S, based on measured values. If the SSB-based measurement timing configuration (SMTC) period is greater than 20 ms, and if the DRX cycle is less than or equal to 0.64 s, M1=2, and in other cases, M1=1.

N1 may be determined by Table 4 as follows:

TABLE 4

| | N1 | | | Nₛₑᵣᵥ [number of |
|---|---|---|---|---|
| DRX cycle[s] | FR1 | FR2-1 | FR2-2 | DRX cycles] |
| 0.32 | 1 | 8 | 12 | M1*N1*4 |
| 0.64 | | 5 | 8 | M1*N1*4 |
| 1.28 | | 4 | 6 | N1*2 |
| 2.56 | | 3 | 5 | N1*2 |

The cell selection determination standard S may be satisfied if Sᵣₓₗₑᵥ>0, which corresponds to SS-RSRP, where Sᵣₓₗₑᵥ is calculated in Equation (1) below, and if S_{qual}>0, which corresponds to SS-RSRQ, where S_{qual} is calculated in Equation (2) below.

$${S}_{r x l e v} = {Q}_{rxlevmeas} - ( {Q}_{r x l evm i n} + {Q}_{r x l evmi noffset} ) - {P}_{c o m p e n s a t i o n} - {Q}_{offsettemp} \qquad ( 1 )$$

$${S}_{qual} = {Q}_{q u a l m e a s} - ( {Q}_{qualmin} + {Q}_{qualminoffset} ) - {Q}_{offsettemp} \qquad ( 2 )$$

In Equations (1) and (2), Qᵣₓₗₑᵥₘₑₐₛ is measured SS-RSRP, Q_{qualmeas} is measured SS-RSRQ, Qᵣₓₗₑᵥₘᵢₙ is the minimum size level of received signals needed by the serving cell, and may be received by the UE as system information, and Q_{qualmin} is the minimum quality level of received signals needed by the serving cell, and may be received by the UE as system information. Remaining parameters are presented in the relevant standard. The UE may determine the serving cell's SS-RSRP by filtering at least two measurement values spaced apart at least by half the DRX cycle. The UE may determine the serving cell's SS-RSRQ by filtering at least two measurement values spaced apart at least by half the DRX cycle.

If the UE determines that the serving cell cannot satisfy the cell selection determination standard S during a continuous DRX cycle of Nₛₑᵣᵥ, the UE may initiate measurement of all peripheral cells other than the serving cell. If the UE fails to find a new appropriate cell for 10 s, the UE may initiate a cell selection procedure regarding the selected public land mobile network (PLMN).

In connection with receiving a paging message from the core network, the UE may monitor one paging occasion (PO) during a DRX cycle. The PO is a set of PDCCH monitoring occasions, and may be configured by multiple time slots (subframes or OFDM symbols) in which paging control information may be received. A paging frame (PF) is one radio frame (10 ms), and may include one or multiple POs or the PO's starting point. The PF and the PO may be determined by the following algorithm.

The SFN for the PF is determined by (SFN+PF_offset) mod T=(T div N)*(UE_ID mod N), wherein PF_offset refers to an offset for determining the PF, T refers to a DRX cycle, N refers to the number of (cell-common or cell-specific) PFs per DRX cycle and is determined by an upper-level signal (for example, system information), and UE_ID refers to a UE ID (5G-S-TMSI) and is determined by the core network. PFs determined by the N refer to paging frames commonly applied to UEs in the cell, and is referred to as cell-common PFs herein.

i_s which indicates a PO index is determined by i_s=floor (UE_ID/N) mod Ns, wherein Ns refers to the number of POs in one PF, and may be determined by an upper-level signal (for example, system information).

For example, assuming that PF_offset=3, T=128, N=T/4=32, Ns=4, the UE_ID mod 32 of the UE_ID is 1, and the floor (UE_ID/32) mod 4 of the UE_ID is 1, then

(SFN+3)mod 128=(128 div 32)*(UE_ID mod 32)=4*1=4,

i_s=floor(UE_ID/32)mod 4=1
may be determined. Therefore, the PFs to be received by a UE having the above UE_ID are determined to be radio frames, the SFN of which is 1, 129, 257, . . . , among cell-common PFs, and the PO may be determined to be the (i_s+1)^{th} PO among four POs in the PFs.

The PEI has been introduced to reduce power consumed by a UE while monitoring and receiving a paging control channel and a paging data channel in each DRX cycle. The UE may monitor or receive one PEI occasion (PEI-O) before receiving a paging during a DRX cycle. If the UE receives a PEI indicating a paging reception sub-group to which the UE belongs, the UE may monitor the relevant PO. If the UE fails to detect the PEI during a PEI occasion, or if the PEI does not indicate a paging reception sub-group to which the UE belongs, the UE does not need to monitor the relevant PO, which may reduce UE power consumption.

The UE may determine a PEI occasion as follows. The PEI occasion is spaced apart backwards by the subframe offset with reference to a radio frame of a reference point which is spaced apart forwards by pei-FrameOffset with reference to the PF including the relevant PO, and the UE may monitor the PEI in the PEI occasion determined in the above manner. The pei-FrameOffset, subframe offset, and the like may be determined by an upper-level signal (for example, system information).

In 5G systems, a new UE state (RRC_INACTIVE) has been defined to reduce the energy and time consumed for the UE's initial access. The RRC_INACTIVE UE may perform the following processes in addition to operations performed by an RRC_IDLE UE.
Storing access stratum (AS) information necessary for cell access
UE-specific DRX cycle operation configured by the RRC layer
Configuring a radio access network (RAN)-based notification area (RNA) which may be used during a handover by the RRC layer, and periodically performing update
Monitoring a RAN-based paging message transmitted through an inactive-radio network temporary identifier (I-RNTI)

The UE in the RRC_CONNECTED state may receive an RRC release indication from the gNB and may change from the RRC_CONNECTED state to an RRC_INACTIVE/RRC_IDLE state.

The UE in the RRC_INACTIVE/RRC_IDLE state may perform an RA, complete the entire RA procedure, and change from the RRC_INACTIVE/RRC_IDLE state to the RRC_CONNECTED state.

Hereinafter, a scheduling method in which the gNB transmits DL data to the UE, or indicates the UE's UL data transmission, will be described.

DL control information (DCI) may be control information transmitted from the gNB to the UE through the DL. The DCI may include DL data scheduling information or UL data scheduling information regarding a specific UE. In general, the gNB may independently perform channel coding for each UE with regard to the DCI, and may transmit the same to each UE through a PDCCH.

With regard to a UE to be scheduled, the gNB may apply and operate a predetermined DCI format according to the purpose, such as whether the same is scheduling information regarding DL data (DL assignment), whether the same is scheduling information regarding UL data (UL grant), or whether the same is DCI for power control.

The gNB may transmit DL data to the UE through a PDSCH. Scheduling information such as detailed mapping locations in time and frequency domains of the PDSCH, the modulation scheme, HARQ-related control information, and power control information, may be provided from the gNB to the UE through DCI related to DL data scheduling information among DCI transmitted through a PDCCH.

The UE may transmit UL data to the gNB through a PUSCH. Scheduling information such as detailed mapping locations in time and frequency domains of the PUSCH, the modulation scheme, HARQ-related control information, and power control information, may be provided from the gNB to the UE through DCI related to UL data scheduling information among DCI transmitted through a PDCCH.

The time-frequency resource to which the PDCCH is mapped may be referred to as a CORESET, which is configured in all or part of frequency resources in a bandwidth supported by the UE in the frequency domain. One or multiple OFDM symbols may be configured as the same in the time domain, and this may be defined as a CORESET duration. The gNB may configure one CORESET or multiple CORESETs for the UE through upper layer signaling (e.g., system information, MIB, or RRC signaling). The description that the gNB configures a CORESET for the UE may mean that the gNB provides the UE with information such as the CORESET identity, the CORESET's frequency location, and the CORESET's symbol length. Pieces of information provided from the gNB to the UE to configure a CORESET may include at least a part of the information included in Table 5 below.

TABLE 5

| | |
|---|---|
| ControlResourceSet ::= | SEQUENCE { |
| controlResourceSetId | ControlResourceSetId, |

(COREST identity)

| | |
|---|---|
| frequencyDomainResources | BIT STRING (SIZE (45)), |

(frequency domain resource)

| | |
|---|---|
| duration | INTEGER (1..maxCoReSetDuration), |

(CORES duration)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| interleaverSize | ENUMERATED {n2, n3, n6}, |

(interleaver size)

| | |
|---|---|
| shiftindex | INTEGER(0..maxNrofPhysicalResourceBlocks-1) |

```
  OPTIONAL -- Need S
          (interleaver shift)
      },
```

| | |
|---|---|
| nonInterleaved | NULL |

},

| | |
|---|---|
| precoderGranularity | ENUMERATED {sameAsREG-bundle, allContiguousRBs}, |

(precoding unit)

| | |
|---|---|
| tci-StatesPDCCH-ToAddList | SEQUENCE(SIZE (1..maxNrofTCI-StatesPDCCH)) |

```
  OF TCI-StateId OPTIONAL, -- Cond NotSIB1-initialBWP
      (QCL configuration information)
```

| | |
|---|---|
| tci-StatesPDCCH-ToReleaseList | SEQUENCE(SIZE (1..maxNrofTCI-StatesPDCCH)) |

```
  OF TCI-StateId OPTIONAL, -- Cond NotSIB1-initialBWP
      (QCL configuration information)
```

| | | |
|---|---|---|
| tci-PresentInDCI | ENUMERATED {enabled} | OPTIONAL, -- |

```
  Need S
  (QCL indicator configuration information in DCI)
```

| | | |
|---|---|---|
| pdcch-DMRS-ScramblingID | INTEGER (0..65535) | OPTIONAL, |

-- Need S
(PDCCH DMRS scrambling identifier)
}

A CORESET may be configured by N_{RB}^{CORESET} RBs in the frequency domain and may be configured by N_{symb}^{CORESET} ∈{1,2,3} symbols in the time domain. An NR PDCCH may be configured by one or multiple control channel elements (CCEs). One CCE may be configured by six resource element groups (REGs), and each REG may be defined as one RB during one OFDM symbol. In one CORESET, REGs may be indexed in the time-first order, starting from REG index 0 in the CORESET's first CORESET symbol/lowest RB.

As a PDCCH-related transmission method, an interleaved type and a non-interleaved type may be supported. The gNB may configure, for the UE, whether interleaved or non-interleaved transmission is performed for each CORESET through upper layer signaling. Interleaving may be performed at the REG bundle level. The REG bundle may be defined as one REG or a set of multiple REGs. Based on the gNB's configuration regarding whether interleaved or non-interleaved transmission is performed, the UE may determine a CCE-to-REG mapping type in the corresponding CORESET as in Table 6 below.

TABLE 6
The CCE-to-REG mapping for a control-resource set can be interleaved or non-
interleaved and is described by REG bundles:

| | |
|---|---|
| - | REG bundle i is defined as REGs {iL,iL←1,...,iL→L−1} where L is the REG bundle |
| | size, i = 0,1, ... , N_{REG}^{CORESET} /L − 1, and N_{REG}^{CORESET} = N_{RB}^{CORESET} N_{symb}^{CORESET} is the |
| | number of REGs in the CORESET |
| - | CCE j consists of REG bundles {f(6j/L),f(6j/L←1),...,f(6j/L←6/L−1)} where f(·) |
| | is an interleaver |

For non-interleaved CCE-to-REG mapping, L = 6 and f(x) = x.
For interleaved CCE-to-REG mapping, L ∈ {2,6}for N_{symb}^{CORESET} = 1 and L ∈
{N_{symb}^{CORESET},6} for N_{symb}^{CORESET} ∈ {2,3}. The interleaver is defined by

```
f(x) = (rC + c + n_{shift}) mod (N_{REG}^{CORESET} /L)
      x = cR + r
    r = 0,1, ... , R − 1
    c = 0,1, ... , C − 1
  C = N_{REG}^{CORESET} /(LR)
```

where R ∈ {2,3,6}.

The gNB may provide the UE with configuration information regarding the symbol to which the PDCCH is mapped in the slot, the transmission period, and the like through signaling.

A description of a search space for a PDCCH is as follows. The number of CCEs necessary to transmit a PDCCH may be 1, 2, 4, 8, or 16 according to aggregation levels (ALs), and different number of CCEs may be used to implement link adaption of a PDCCH. For example, in AL=L, one PDCCH may be transmitted through L CCEs. The UE performs blind decoding for detecting a signal although the UE has no information regarding the PDCCH. Thus, a search space indicating a set of CCEs may be defined. The search space is a set of PDCCH candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured ALs.

The search spaces may be classified into common search spaces (CSSs) and UE-specific search spaces (USSs). A group of UEs or all UEs may search a CSS of the PDCCH to receive cell-common control information such as dynamic scheduling regarding system information or a paging message. For example, the UE may receive PDSCH scheduling allocation information for reception of system information by searching the CSS for the PDCCH. In a CSS, a group of UEs or all UEs need to receive the PDCCH, and the CSS may thus be defined as a predetermined set of CCEs. Scheduling allocation information regarding a UE-specific PDSCH or PUSCH may be received by searching the UE-SSS for the PDCCH. The UE-SSS may be defined UE-specifically as a function of various system parameters and the ID of the UE.

Configuration information of the search space for the PDCCH may be configured for the UE by the base station through upper layer signaling (e.g., SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (CSS or UE-SSS), a combination of an RNTI and a DCI format to be monitored in the corresponding search space, a CORESET index for monitoring the search space, and the like. For example, parameters of the search space for the PDCCH may include the following pieces of information given in Table 7 below.

TABLE 7

| | |
|---|---|
| SearchSpace ::= | SEQUENCE { |
| searchSpaceId | SearchSpaceId, |

(search space identity)

| | |
|---|---|
| controlResourceSetId | ControlResourceSetId |

```
OPTIONAL, -- Cond SetupOnly
    (CORESET identity)
  monitoringSlotPeriodicityAndOffset CHOICE {
    (monitoring slot level periodicity and offset)
```

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

}
OPTIONAL, -- Cond Setup

| | |
|---|---|
| duration | INTEGER (2..2559) |

OPTIONAL, -- Need R
(monitoring duration)

| | |
|---|---|
| monitoringSymbolsWithinSlot | BIT STRING (SIZE (14)) |

OPTIONAL, -- Cond Setup
(monitoring symbol locations within slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, |

n6, n8},

| | |
|---|---|
| aggregationLevel2 | ENUMERATED {n0, n1, n2, n3, n4, n5, |

n6, n8},

| | |
|---|---|
| aggregationLevel4 | ENUMERATED {n0, n1, n2, n3, n4, n5, |

n6, n8},

| | |
|---|---|
| aggregationLevel8 | ENUMERATED {n0, n1, n2, n3, n4, n5, |

n6, n8},

| | |
|---|---|
| aggregationLevel16 | ENUMERATED {n0, n1, n2, n3, n4, n5, |

n6, n8}
}
OPTIONAL, -- Cond Setup

| | |
|---|---|
| searchSpaceType | CHOICE { |

(search space type)

| | |
|---|---|
| common | SEQUENCE { |

(CSS )

| | |
|---|---|
| dci-Format0-0-AndFormat1-0 | SEQUENCE { |
| ... | |
| } | |

OPTIONAL, -- Need R

| | |
|---|---|
| dci-Format2-0 | SEQUENCE { |
| nrofCandidates-SFI | SEQUENCE { |
| aggregationLevel1 | ENUMERATED {n1, |

n2} OPTIONAL, -- Need R

| | |
|---|---|
| aggregationLevel2 | ENUMERATED {n1, |

n2} OPTIONAL, -- Need R

| | |
|---|---|
| aggregationLevel4 | ENUMERATED {n1, |

n2} OPTIONAL, -- Need R

| | |
|---|---|
| aggregationLevel8 | ENUMERATED {n1, |

n2} OPTIONAL, -- Need R

| | |
|---|---|
| aggregationLevel16 | ENUMERATED {n1, |

```
n2} OPTIONAL -- Need R
          },
          ...
        }
OPTIONAL, -- Need R
```

| | |
|---|---|
| dci-Format2-1 | SEQUENCE { |

```
          ...
        }
OPTIONAL, -- Need R
```

| | |
|---|---|
| dci-Format2-2 | SEQUENCE { |

```
          ...
        }
OPTIONAL, -- Need R
```

| | |
|---|---|
| dci-Format2-3 | SEQUENCE { |
| dummy1 | ENUMERATED {sl1, sl2, |

sl4, sl5, sl8, sl10, sl16, sl20} OPTIONAL, -- Cond Setup

| | |
|---|---|
| dummy2 | ENUMERATED {n1, n2}, |

```
          ...
        }
OPTIONAL -- Need R
      },
```

| | |
|---|---|
| ue-Specific | SEQUENCE { |

(UE-SSS)

| | |
|---|---|
| dci-Formats | ENUMERATED {formats0- |

```
0-And-1-0, formats0-1-And-1-1},
        ...,
      }
  }
OPTIONAL -- Cond Setup2
}
```

Based on configuration information, the base station may configure one or multiple search space sets for the UE. The base station may configure search space set 1 and search space set 2 for the UE. In search space set 1, the UE may be configured to monitor DCI format A scrambled by an X-RNTI in a CSS, and in search space set 3, the UE may be configured to monitor DCI format B scrambled by a Y-RNTI in a UE-SSS.

According to the configuration information transmitted by the base station, a CSS or a UE-SSS may include one or multiple search space sets. For example, search space set #1 and search space set #2 may be configured as a CSS, and search space set #3 and search space set #4 may be configured as a UE-SSS.

In a CSS, the UE may monitor combinations of DCI formats and RNTIs given below, but the disclosure is not limited thereto.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In a UE-SSS, the UE may monitor combinations of DCI formats and RNTIs given below, but the disclosure is not limited thereto.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs may follow the definition and usage given below, but the disclosure is not limited thereto.
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
RA RNTI (RA-RNTI): used to schedule a PDSCH in a RA step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS

The DCI formats enumerated above may follow the definitions given in Table 8 below.

TABLE 8

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

The search space at aggregation level L in connection with CORESET p and search space set s may be expressed Equation (3) as follows.

$$L \cdot \{ ( {Y}_{p , {n}_{s , f}^{μ}} + ⌊ \frac{{m}_{s , {n}_{CI}} \cdot {N}_{C C E , p}}{L \cdot {M}_{s , max}^{( L )}} ⌋ + {n}_{CI} ) mod ⌊ \frac{{N}_{C C E , p}}{L} ⌋ \} + i \qquad ( 3 )$$

In Equation (3):
L: aggregation level
   n_{CI}: carrier index
   N_{CCE,p}: total number of CCEs existing in control resource set p
   n_{s,f}^{μ}: slot index
   M_{s,max}^{(L)}: number of PDCCH candidates at aggregation level L
   m_{s,n}_{_{CI}}=0, . . . , M_{s,max}^{(L)}−1: PDCCH candidate index at aggregation level L
   i=0, . . . , L−1

The Y_{p,n}_{_{s,f}}^{μ} value is calculated in Equation (4) as follows.

$${Y}_{p , {n}_{s , f}^{μ}} = ( {A}_{p} \cdot {Y}_{p , {n}_{s , f}^{μ} - 1} ) mod D \qquad ( 4 )$$

In Equation (4), Y_{p,-1}=n_{RNTI}≠0, Aₚ=39827 for pmod3=0, Aₚ=39829 for pmod3=1, Aₚ=39839 for pmod3=2, D=65537, and
n_{RNTI}: UE identifier

The Y_{p,n}_{_{s,f}}^{μ} value may correspond to 0 in a CSS and to a value changed by the UE's identity (C-RNTI or ID configured for the UE by the base station) and the time index in a UE-SSS.

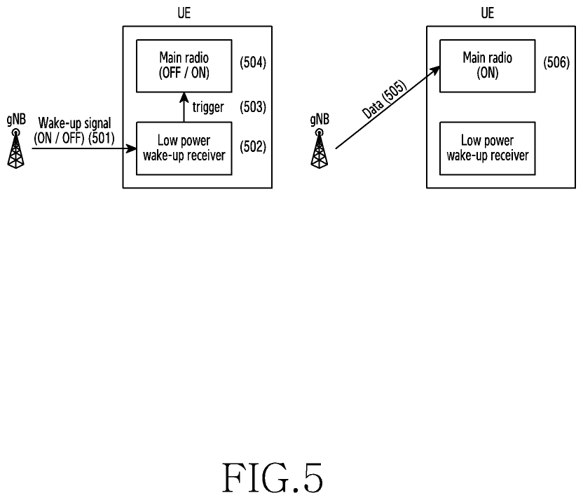

FIG. 5 illustrates state transitions of a gNB and a UE and the state of the UE according to the gNB state, according to an embodiment.

A 5G UE may need to periodically wake up once per eDRX cycle, and this may dominate power consumption during a period of time having no signaling or data traffic. Power consumption could be substantially reduced if the UE could wake up only when triggered (for example, through paging). Substantial reduction in power consumption may be accomplished by a method, as in FIG. 5, wherein the main radio (MR) (for example, existing NR radio) is triggered by using a wake-up signal (WUS), and the main radio is turned on only when data transmission/reception is necessary by using a wake-up receiver (WUR) (or low power wake-up receiver (LP-WUR) (LR)) which is a separate receiver capable of monitoring the WUS with super-low power.

Referring to FIG. 5, in step 501, the gNB may transmit a WUS corresponding to ON or OFF to the UE. Prior to step 501, the gNB may periodically transmit a WUR-dedicated synchronization signal (a low power-synchronization signal (LP-SS), a new synchronization signal, or the like) such that, when the UE receives the WUS, the WUR can make time or frequency synchronization.

In step 502, the UE may receive a WUS by using the WUR. The UE may make time or frequency synchronization of the WUR by receiving a WUR-dedicated synchronization signal or legacy synchronization signal such that time or frequency synchronization of the WUR can be performed before receiving the WUS.

In step 503, the UE may trigger the main radio, which is in an OFF or ON state, based on information indicating that the received signal corresponds to ON or OFF.

In step 504, the UE may wake up the main radio or may configure a power off state. Instead of a fully OFF state, a deep sleep (DSP) or an ultra-deep sleep (UDS) state may also be configured.

In step 505, if data traffic to be transmitted from the gNB to the UE has occurred, and if the WUS transmitted by the gNB in step 501 is a signal corresponding to ON, the main radio may be turned on in step 506, and the UE may receive data transmitted by the gNB through the main radio instead of the WUR.

Herein, power consumed to monitor the WUS depends on the WUS design and hardware modules of the WUR used to detect and process signals. Thus, it is expected that the gain will be maximized with regard to devices which are sensitive to power and have small form factors, including wearable devices, and IoT use cases (such as industrial sensors and controllers).

A UE including a WUR may report to the gNB that the UE is capable of waking up the main radio by using the WUR or may report capability information to the gNB to indicate that the UE includes a WUR.

The UE may report capability information regarding the WUR to the gNB through the UE capability report procedure in FIG. 4.

The UE may report capability information regarding the WUR to the gNB through a step of at least one of the RA preamble or the UL data channel in the RA procedure in FIG. 3. Sets of RA preambles which may be transmitted by the UE including a WUR may be transmitted to the UE as system information. The UE may select a RA preamble from the sets received by the UE, and may transmit the RA preamble in step 310 of the RA procedure in FIG. 3, based on the selected RA preamble. After reporting capability information regarding the WUR to the gNB, the UE may receive information indicating whether or not to use the WUR from the gNB through upper layer signaling or physical signal.

In case that the gNB supports the UE including a WUR (for example, in case that the gNB has hardware capable of transmitting a WUS), the gNB may determine whether or not to use the WUR after receiving capability information regarding the WUR from the UE. The gNB may transmit a signal indicating configuration information regarding whether or not to use the WUR, or for receiving a WUS, to the UE. The gNB may transmit, to the UE, at least one of indication information indicating reception of a WUS by the UE or activation of the WUR, or indication information indicating transmission of a WUS by the gNB. The UE may turn off the main radio after a slot configured by the gNB (or defined by specifications), from a slot in which a signal is received, and may turn on the WUR for monitoring the WUS. The UE may transmit at least one of feedback indicating reception of a signal indicating whether or not to use the WUR before turning off the main radio, or feedback indicating that the main radio is turned off, and the WUR is turned on, to the gNB.

When the gNB does not support a UE having a WUR, the gNB may receive capability information regarding the WUR from the UE and then transmit a signal to the UE to indicate that the WUR cannot be used. The UE may transmit feedback to the gNB to indicate reception of the signal indicating that the WUR cannot be used. By using an existing power saving method (for example, C-DRX or I-DRX such as paging), the UE may perform operations by means of parameters of the existing power saving method configured by the gNB.

After reporting the capability of a UE having a WUR and after a procedure regarding whether the gNB supports (or allows) the WUR, the UE's WUR may receive a WUS and may perform operations of turning on and off the UE's main radio. The UE may perform an operation of turning on/off the main radio and an operation of reporting the capability of the UE having a WUR, or operation procedures regarding whether the gNB supports the WUR regardless of each other. For example, even if the UE's capability reporting operation and allowing procedure have not been performed, the gNB may transmit a signal to the UE to indicate configuration information for receiving a WUS, or regarding whether to use the WUR (or indicating activation/deactivation thereof). Accordingly, among UEs that receive signals from the gNB, a UE having a WUR may turn on/off the main radio through the WUR.

After the UE's capability reporting operation and the gNB allowing procedure are performed, the operation of turning on/off the main radio through the WUR may be applied to all UEs (for example, RRC_CONNECTED UEs, RRC_IDLE/RRC_INACTIVE UEs) in the cell supported by the gNB. When the UE's capability reporting operation and the gNB allowing procedure are not performed, the operation of turning on/off the main radio through the WUR may be applied to an RRC_IDLE/RRC_INACTIVE UE which camps in the cell supported by the gNB.

An RRC_CONNECTED UE or an RRC_IDLE/RRC_INACTIVE UE which camps in the cell supported by the gNB may measure a new synchronization signal or existing synchronization signal through the WUR, may compare the measurement value with a reference value configured by an upper-level signal from the gNB, and may determine not to operate the WUR if the measurement value is less than the reference value. The UE may determine to operate the WUR if the measurement value is greater than the reference value.

Embodiments of the disclosure may include at least one from among all of various operations of a UE including a WUR and a gNB disclosed hereinafter, parts thereof, or a combination of parts thereof.

When the UE's main radio is on, the UE may receive a DL signal (or data) from the gNB through the main radio. The description that the main radio is on may also be expressed as the main radio is turned on, the main radio is activated, or the like. However, the description is not limited thereto and may be expressed by similar or substantially equivalent expressions. The description that the main radio is activated may mean that the UE or main radio's specific components (e.g., radio frequency (RF), baseband (BB), etc.) are turned on or activated, or may be defined in the relevant standard. However, the description that the main radio is activated may include parameters equivalent or substantially similar thereto, or operations performed by such parameters.

Alternatively, the description that the main radio is activated may include an operation in which the UE or main radio receives a specific channel or signal defined in the relevant standard (for example, an SS/PBCH block including a synchronization signal, or a PDCCH).

When the UE's main radio is off, it may be considered that the UE is in a sleep range, or the UE may receive no DL signal (or data) from the gNB. The description that the main radio is off may also be expressed as the main radio is turned off, the main radio is deactivated, or the like. However, the description is not limited thereto, and may be expressed by similar or substantially equivalent expressions. The description that the main radio is deactivated may indicate that the UE or main radio's specific components (e.g., RF, BB, or the like) are turned off or deactivated, or may be defined in the relevant standard. However, the description that the main radio is deactivated may include parameters equivalent or substantially similar thereto, or operations performed by such parameters, or may include an operation in which the UE or main radio no longer receives a specific channel or signal defined in the relevant standard (for example, an SS/PBCH block including a synchronization signal, or a PDCCH).

As described above, to reduce power consumption, the main radio may be triggered on through the WUR only when the UE has received a WUS from the gNB, thereby enabling the main radio to receive a DL signal from the gNB, and the main radio may be turned off if no WUS is received. In this regard, the disclosure provides UE operations necessary when C-DRX is configured for the UE in the RRC_CONNECTED state so as to discontinuously monitor a PDCCH, and when the main radio is maintained in a sleep state in a situation in which a configuration has been made to receive the WUS through the WUR. Specifically, the disclosure defines operations of the main radio and the WUR, and provides a method and a device for enabling the UE to receive a WUS by means of the UE operations and enabling the main radio to transmit 5G channels and signals.

Herein, operations or procedures described as being performed by the main radio or WUR with regard to a UE having a WUR (for example, a UE capable of receiving a WUS) may also be understood as being performed by a UE having a WUR (for example, a UE capable of receiving a WUS). Hereinafter, a DL signal may include control information (e.g., DCI) and/or data transmitted from a gNB to a UE. For example, a DL signal may refer to a channel (for example, PDCCH/PDSCH) for transmitting control information and/or data. In addition, an UL signal may include DCI and/or data transmitted from a UE to a gNB. For example, an UL signal may refer to a channel (for example, PUCCH/PUSCH) for transmitting control information and/or data.

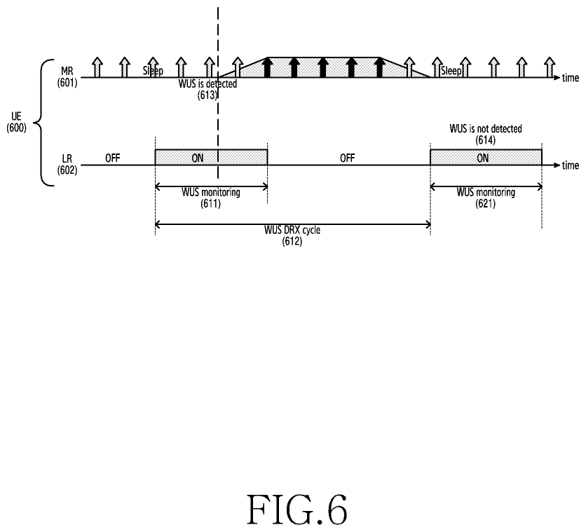

FIG. 6 illustrates when a UE having a WUR transmits UL signals, according to an embodiment.

Referring to FIG. 6, the UE in FIG. 6 includes a main radio 601 (|, MR) and a WUR 602 (for example, LR). The main radio 601 may be configured to be in an RRC_CONNECTED state by an upper-level signal from the gNB, and a situation in which C-DRX is configured by an upper-level signal may be considered. The WUR 602 may operate by an offset which indicates a time resource to start monitoring such that a WUS can be monitored, and a WUS DRX cycle 612 at which monitoring is repeatedly performed. In FIG. 6, the UE 600 may receive WUR configuration information from the gNB. When the UE 600 is instructed by the gNB to activate the WUR, or the UE 600 has activated the WUR, the main radio 601 of the UE 600 may not perform C-DRX configured by the gNB. Instead, the WUR 602 of the UE 600 may monitor a WUS during the WUS monitoring range 611 at each WUS DRX cycle 612. When the WUR 602 has received a WUS (613), the UE 600 may turn on the main radio 601. In addition, the main radio 601 may receive a DL signal. After receiving a DL signal, the main radio 601 may be again turned off by a timer configured by the gNB (for example, a timer that indicates an ON range). Alternatively, the WUR 602 may again receive a WUS including an indication by which the main radio 601 is turned off.

In case that the WUR 602 fails to receive a WUS during the WUS monitoring range 621 (614), the WUR 602 may monitor the WUS during the WUS monitoring range 621 and may then be turned off.

In FIG. 6, at least one of the WUS DRX cycle 612, the WUS monitoring range 621, or the main radio ON range indication timer may be configured by the gNB through an upper-level signal.

A situation in which C-DRX is configured for the UE 600 is considered in FIG. 6, but the above-described embodiment may also be applied to when the PDCCH is monitored continuously because no C-DRX is configured for the UE. For example, in case that the UE has activated the WUR, the UE's main radio may not perform continuous PDCCH monitoring. Instead, the UE's WUR may monitor the WUS during the WUS monitoring range at each WUS DRX cycle. Remaining UE operations are as described with reference to FIG. 6.

As to the UE transmitting UL signals, in a first embodiment, when the WUR 602 has received no WUS for triggering ON of the main radio during the WUS monitoring range 621 (614), the MAC entity of the main radio 601 may not transmit a periodic SRS and a semi-persistent SRS configured by an upper-level signal, and may not report CIS transmitted in a PUCCH configured by an upper-level signal and semi-persistent CSI configured to be transmitted in a PUSCH. Alternatively, when the WUR 602 has received no WUS for triggering ON of the main radio during the WUS monitoring range 621 (614), the MAC entity of the main radio 601 may not transmit aperiodic CSI and aperiodic SRS transmitted in a PUSCH.

If the WUR 602 has received a WUS for triggering ON of the main radio during the WUS monitoring range 611 (613), the MAC entity of the main radio 601 may transmit a periodic SRS and a semi-persistent SRS configured by an upper-level signal, and may report, to the gNB, CIS transmitted in a PUCCH configured by an upper-level signal and semi-persistent CSI configured to be transmitted in a PUSCH.

In a second embodiment, when the WUS received by the WUR 602 has not triggered ON of the main radio, the MAC entity of the main radio 601 may not transmit a periodic SRS and a semi-persistent SRS configured by an upper-level signal, and may not report, to the gNB, CIS transmitted in a PUCCH configured by an upper-level signal and semi-persistent CSI configured to be transmitted in a PUSCH. Alternatively, when the WUS received by the WUR 602 has not triggered ON of the main radio, the MAC entity of the main radio 601 may not transmit aperiodic CSI and aperiodic SRS transmitted in a PUSCH.

If the WUS received by the WUR 602 has triggered ON of the main radio, the MAC entity of the main radio 601 may transmit a periodic SRS and a semi-persistent SRS configured by an upper-level signal, and may report, to the gNB, CIS transmitted in a PUCCH configured by an upper-level signal and semi-persistent CSI configured to be transmitted in a PUSCH.

In a third embodiment, when the main radio is not turned on (or in no operation of the timer supposed to operate if the WUR has received a WUS and if the main radio is turned on), the MAC entity of the main radio 601 may not transmit a periodic SRS and a semi-persistent SRS configured by an upper-level signal, and may not report, to the gNB, CIS transmitted in a PUCCH configured by an upper-level signal and semi-persistent CSI configured to be transmitted in a PUSCH. Alternatively, when the main radio is not turned on (or when the timer is not supposed to operate if the WUR has received a WUS and if the main radio is turned on), the MAC entity of the main radio 601 may not transmit aperiodic CSI and aperiodic SRS transmitted in a PUSCH.

If the main radio is turned on (or when the timer is supposed to operate if the WUR has received a WUS and if the main radio is turned on), the MAC entity of the main radio 601 may transmit a periodic SRS and a semi-persistent SRS configured by an upper-level signal, and may report, to the gNB, CIS transmitted in a PUCCH configured by an upper-level signal and semi-persistent CSI configured to be transmitted in a PUSCH.

In a fourth embodiment, when the WUR 602 has received no WUS for triggering ON of the main radio during the WUS monitoring range 621, and the main radio is not turned on (or the timer is not supposed to operate if the WUR has received a WUS and if the main radio is turned on), the MAC entity of the main radio 601 may not transmit a periodic SRS and a semi-persistent SRS configured by an upper-level signal, and may not report, to the gNB, CIS transmitted in a PUCCH configured by an upper-level signal and semi-persistent CSI configured to be transmitted in a PUSCH. Alternatively, when the WUR 602 has received no WUS during the WUS monitoring range 621, and the main radio is not turned on (or the timer is not supposed to operate if the WUR has received a WUS and if the main radio is turned on), the MAC entity of the main radio 601 may not transmit aperiodic CSI and aperiodic SRS transmitted in a PUSCH.

If the WUR 602 has received a WUS during the WUS monitoring range 611, and if the main radio is turned on (or when the timer is supposed to operate if the WUR has received a WUS and if the main radio is turned on), the MAC entity of the main radio 601 may transmit a periodic SRS and a semi-persistent SRS configured by an upper-level signal, and may report, to the gNB, CIS transmitted in a PUCCH configured by an upper-level signal and semi-persistent CSI configured to be transmitted in a PUSCH.

In a fifth embodiment, definitions regarding whether a WUS is received by the WUR and regarding whether the ON state is changed by the main radio's ON triggering may be made by an active time such that, if it is not the active time, the MAC entity of the main radio 601 may not transmit a periodic SRS and a semi-persistent SRS configured by an upper-level signal, and may not report, to the gNB, CIS transmitted in a PUCCH configured by an upper-level signal and semi-persistent CSI configured to be transmitted in a PUSCH. As an example, the active time may include the following time:
If reception of a WUS is configured or activated,
   the WUR 602 has received a WUS for trigging ON of the main radio during a WUS monitoring range 611 (613), or
   the WUS received by the WUR 602 has triggered ON of the main radio, or
   the main radio is turned on (or in an operation of the timer supposed to operate if the WUR has received a WUS and if the main radio is turned on), or
   the WUR 602 has received a WUS during a WUS monitoring range 611, and the main radio is turned on (or in an operation of the timer supposed to operate if the WUR has received a WUS and if the main radio is turned on).

Alternatively, if it is not the active time, the MAC entity of the main radio 601 may not transmit aperiodic CSI and aperiodic SRS transmitted in a PUSCH.

If it is the active time, the MAC entity of the main radio 601 may transmit a periodic SRS and a semi-persistent SRS configured by an upper-level signal, and may report, to the gNB, CIS transmitted in a PUCCH configured by an upper-level signal and semi-persistent CSI configured to be transmitted in a PUSCH.

Hereinafter, a procedure for waking up the main radio when the main radio is in a sleep state will be described.

The gNB may transmit a WUS to a UE if there is a channel or signal to be transmitted to the UE. The UE or WUR may receive the WUS and turn on the main radio. The WUS receiving operation itself may be an instruction to wake up the main radio. The WUS may include K information bits, and information corresponding to an instruction to wake up the main radio may be mapped to the K information bits. For example, in case that the WUS includes one bit of information, “1” may indicate ON, and “0” may indicate OFF.

From the viewpoint of gNB transmission, it may be predefined at which timepoint a WUS will be transmitted prior to transmission of a channel or signal. From the viewpoint of UE reception, it may be predefined at which timepoint the WUS may be received prior to reception of a channel or signal.

The UE may transmit information regarding a time offset necessary between transmission of the WUS and transmission of the channel/signal to the gNB, and the gNB may configure the time offset between transmission of the WUS and transmission of the channel/signal for the UE, based on the received information. The UE may transmit information regarding a time offset necessary between transmission of the WUS and transmission of the channel/signal to the gNB through a UE capability information reporting procedure, or may transmit the same to the gNB through an RA preamble in an RA procedure, or through a UL data channel. Obviously, this is not limitative, and the UE may transmit information regarding a time offset to the gNB through an upper-level signal, or through various signals. The gNB may configure information regarding the time offset between transmission of the WUS and transmission of the channel/signal for the UE through an RA response (for example, message 2) in a RA procedure or through a DL data channel of RA contention resolution (for example, message 4). Obviously, this is not limitative, and the gNB may configure information regarding the time offset for the UE by an upper-level signal or through various signals.

When the gNB has a periodic channel or a periodic signal to be transmitted to the UE, the UE or WUR may turn on the main radio according to a period that follows configuration information of a periodic channel or a periodic signal configured by the gNB, instead of an operation in which the gNB transmits a WUS each time there is a channel or signal to be transmitted.

The gNB may transmit a WUS only during the first transmission of a periodic channel or a periodic signal, and may omit WUS transmission when the channel or signal is later transmitted repeatedly. In this case, the UE or WUR may turn on the main radio, based on the period that follows the configuration information of a periodic channel or a periodic signal configured by the gNB.

The type of the periodic channel or periodic signal transmitted/received by the gNB and the UE may be predefined. The type of the periodic channel or periodic signal may be configured by the gNB. The gNB may configure the type of the periodic channel or periodic signal for the UE through an RA response (for example, message 2) or through a DL data channel of RA contention resolution (for example, message 4), or may configure the same for the UE through an upper-level signal indicating configuration information for WUS reception or through another upper-level signal.

When the UE has a channel or signal (e.g., physical RA channel (PRACH), an SR, or a buffer status report (BSR)) to be transmitted to the gNB, or in case that the UE performs L1/L3-based measurement, the UE or WUR may turn on the main radio regardless of the WUS transmitted by the gNB.

As to UL transmission from the UE to the gNB or L1/L3-based measurement, the operation in which the WUR receives a WUS and turn on and off the UE's main radio may not be applied.

The type of the UL channel or UL signal transmitted by the UE regardless of the WUS receiving operation, or the L1/L3-based measurement may be predefined. The type of the UL channel or UL signal or the L1/L3-based measurement may be configured by the gNB. The gNB may configure the type of the UL channel or UL signal or the L1/L3-based measurement for the UE through a RA response (for example, message 2) or through an RA contention resolution (|, message 4) DL data channel, or may configure the same for the UE through an upper-level signal indicating configuration information for WUS reception or through another upper-level signal.

An operation for turning off the main radio, when the main radio is in an ON state, will now be described.

The gNB may transmit a sleep signal to a UE if there is no channel or signal to be transmitted to the UE. The UE or WUR may receive the sleep signal and turn off the main radio. The sleep signal receiving operation itself may be an instruction to make the main radio sleep. The sleep signal may be configured as a sequence separate from the WUS. The sleep signal may include information mapped to information corresponding to an instruction to make the main radio sleep among K information bits included in the WUS. For example, in one bit of information, “0” may indicate OFF, and “1” may indicate ON.

The UE's main radio may be turned off if a configured condition is satisfied. The condition configured for the main radio may correspond to a case in which the main radio fails to detect or decode a PDCCH, or a specific channel or signal during a configured range. The gNB may configure configuration information (for example, information including a range and a specific channel or signal) used by the UE to determine to turn off the main radio for the UE through an upper-level signal indicating configuration information for WUS reception or through another upper-level signal.

The UE's main radio may always be turned off after receiving one channel or signal. The main radio may be turned off after the WUR has received a WUS from the gNB, thereby turning on the main radio such that channels or signals are received. The time necessary for the main radio to be turned off after completion of channel or reception may be predefined. The UE may transmit information regarding the time necessary for the main radio to be turned off to the gNB, and the gNB may configure the necessary time for the UE, based on the received information. The information regarding the necessary time transmitted by the UE may be transmitted to the gNB through a UE capability information reporting procedure. The information regarding the necessary time transmitted by the UE may be transmitted to the gNB through a RA preamble or UL data channel. Alternatively, the UE may transmit the information regarding the necessary time to the gNB through an upper-level signal. The gNB may configure information regarding the time necessary for transmission for the UE through a RA response (for example, message 2) or through a DL data channel of RA contention resolution (for example, message 4). Obviously, this is not limitative, and the gNB may configure the information regarding the necessary time for the UE through an upper-level signal.

When the UE or the UE's main radio is in an RRC_CONNECTED state, connected mode DRX (C-DRX) may be configured for the UE such that the main radio wakes up at each DRX cycle and performs PDCCH reception. When the UE or the UE's main radio is in an RRC_CONNECTED state, the UE (or main radio) may be configured to receive a signal indicating whether or not the UE needs to receive a PDCCH at the next DRX cycle.

When the main radio is in an RRC_IDLE/RRC_INACTIVE state, idle mode DRX (I-DRX) may be configured for the UE such that the main radio wakes up at each paging cycle and receives a paging PDCCH. According to an embodiment, in case that the main radio is in an RRC_CONNECTED state, the UE (or main radio) may be configured to receive a signal indicating whether he UE needs to receive a paging PDCCH at the next paging cycle.

Hereinafter, when an operation of indicating ON/OFF based on reception of a WUS by a WUR and a main radio and an operation that follows a C-DRX or I-DRX configuration coexist, a procedure of a UE that operates by the WUR will be provided.

When a UE having a WUR performs operations of receiving a WUS and turning on and off the UE's main radio, the UE may not perform a configuration of C-DRX or I-DRX and an operation that follows the configuration. In this case, instead of performing a configuration of C-DRX or I-DRX and an operation that follows the configuration, the UE may wake up the UE's main radio only upon receiving a WUS that instructs the same to wake up the main radio, and may receive a PDCCH and a PDSCH defined or configured to be received in C-DRX or I-DRX, respectively.

When the UE or the UE's main radio is in an RRC_CONNECTED state, and in case that the WUR performs an operation configured or activated by the gNB, the UE may turn on the main radio in case that the WUR has received a WUS instructing the same to wake up the main radio, and may perform an operation regarding C-DRX configured by the gNB (for example, the main radio receives a PDCCH within drx_onDurationTimer at each DRX cycle). The UE (or main radio) may not perform an operation configured to receive a signal (for example, DCI format 2_6) indicating whether or not the UE has to receive a PDCCH at the next DRX cycle. When the UE or the UE's main radio is in an RRC_IDLE/INACTIVE state, and in case that the WUR performs an operation configured or activated by the gNB, the UE may turn on the main radio in case that the WUR has received a WUS instructing the same to wake up the main radio, and may perform an operation regarding I-DRX configured by the gNB (for example, the main radio wakes up at each paging cycle and receives a paging PDCCH). The UE (or main radio) may not perform an operation configured to receive a signal (for example, DCI format 2_7) indicating whether or not the UE has to receive a paging PDCCH at the next paging cycle.

Instead of the operation according to the configuration regarding C-DRX or I-DRX, the UE may perform an operation for waking up the main radio according to the WUR and WUS and an operation for turning off the main radio. If the WUR performs an operation deactivated by the gNB, operations regarding the C-DRX or I-DRX configured by the gNB may be performed again.

When the UE's WUR performs an operation configured or activated by the gNB, and in case that the UE or WUR has received a WUS such that the main radio is turned on, the UE may transition to an RRC_CONNECTED state or to an RRC_IDLE or RRC_INACTIVE state. It may be predetermined to which state the UE may transition, or may be determined by an upper-level signal regarding the WUR operation configuration from the gNB, or by a separate upper-level signal.

When information regarding the UE's transition is predetermined, the main radio's state may follow the state immediately before the main radio is turned on and off at the last time immediately before the same is currently turned on. As another example of when information regarding the UE's transition is predetermined, the main radio's state may be unaffected by the WUR operation configuration and activation/deactivation. For example, the main radio's state may be determined only by an upper-level signal indicating at least one of RRC_CONNECTED, RRC_IDLE, or RRC_INACTIVE, and the UE may determine that the main radio's state has not been changed by the WUR operation configuration and activation/deactivation.

The WUS may include K information bits, and information regarding to which of the RRC_CONNECTED state, RRC_IDLE state, and RRC_INACTIVE state the main radio is supposed to transition may be mapped to the K information bits.

When the UE or the UE's main radio is in the RRC_CONNECTED state, based on the determined state of the UE, the main radio may wake up at each DRX cycle by means of C-DRX configured by the gNB, thereby receiving a PDCCH, or the UE (or main radio) may be configured by the gNB to receive a signal indicating whether or not the UE has to receive a PDCCH at the next DRX cycle. When an operation for turning off the main radio is performed while the UE is receiving a PDCCH (for example, in a PDCCH receiving range), the UE may preferentially perform a procedure for turning off the main radio.

When the UE or the UE's main radio is in an RRC_IDLE/INACTIVE state, the main radio may wake up at each paging cycle by means of I-DRX configured by the gNB, thereby receiving a paging PDCCH. The UE (or main radio) may be configured by the gNB to receive a signal indicating whether or not the UE has to receive a paging PDCCH at the next paging cycle. When an operation for turning off the main radio is performed while the UE is receiving a paging PDCCH (for example, in a paging PDCCH receiving range), the UE may preferentially perform a procedure for turning off the main radio.

Operations of the UE (or main radio) described above may be performed regardless of the order, and the entity that performs the operations may obviously be either the UE or the main radio.

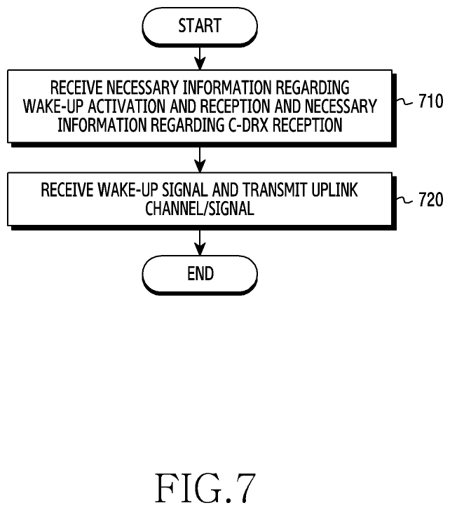

FIG. 7 illustrates a method in which a UE having a WUR transmits UL signals, according to an embodiment.

Referring to FIG. 7, in step 710, the UE may receive a wake-up activation signal from the gNB such that a WUS is received by using the WUR, or may receive a wake-up deactivation signal from the gNB such that the WUS is no longer received by using the WUR. The UE may receive information necessary for WUS reception from the gNB. The UE may receive information including at least one of an indication of whether or not to use the WUR or configuration information for WUS reception from the gNB. The UE may receive information needed to operate in C-DRX from the gNB.

In step 720, the UE may receive a WUS and may transmit a UL channel or signal. No UL signal may be transmitted according to the UE's determination.

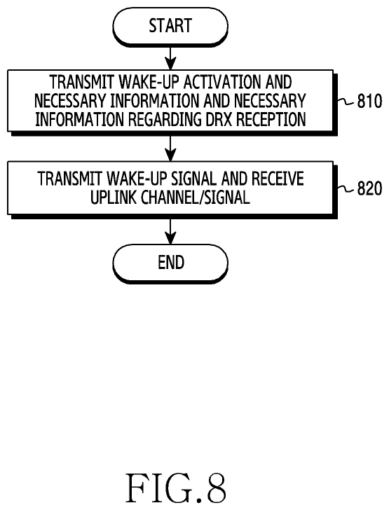

FIG. 8 illustrates a method in which a gNB receives UL signals, according to an embodiment.

Referring to FIG. 8, in step 810, the gNB may transmit a wake-up activation signal to the UE such that a WUS is received by using the WUR. The gNB may transmit a wake-up deactivation signal to the UE such that the WUS is no longer received by using the WUR. The gNB may transmit information necessary for WUS reception to the UE. In an embodiment, the gNB may transmit information including at least one of an indication of whether or not to use the WUR or configuration information for WUS reception to the UE. The gNB may transmit information necessary for C-DRX to the UE.

In step 820, the gNB may transmit a WUS And may receive an UL channel or signal from the UE. No UL channel or signal may be received according to the UE's determination.

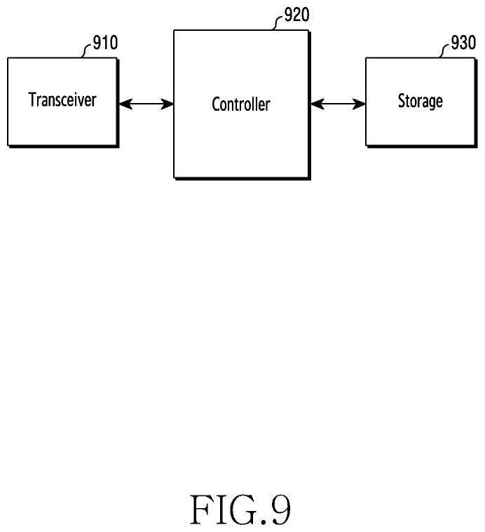

FIG. 9 illustrates a structure of a base station according to an embodiment.

Referring to FIG. 9, the base station may include a transceiver 910, a controller 920, and a storage 930. The transceiver 910, the controller 920, and the storage 930 may be operated according to the above-described communication methods of the base station. A network device may also correspond to the structure of the base station. However, components of the base station are not limited to the above-described example. For example, the base station may include a larger or smaller number of components than the above-described components. For example, the base station may include the transceiver 910 and the controller 920. The transceiver 910, the controller 920, and the storage 930 may be implemented in the form of a single chip.

The transceiver 910 refers to a base station receiver and a base station transmitter as a whole, and may transmit/receive signals with the UE, other base stations, and other network devices. The transmitted/received signals may include control information and data. The transceiver 910 may transmit, for example, system information, synchronization signals, or reference signals to the UE. To this end, the transceiver 910 may include an RF transmitter configured to up-convert and amplify the frequency of transmitted signals, an RF receiver configured to low-noise-amplify received signals and down-convert the frequency thereof, and the like. However, the components of the transceiver 910 are not limited to the RF transmitter and the RF receiver. The transceiver 910 may include wired/wireless transceivers, and may include various components for transmitting/receiving signals. The transceiver 910 may receive signals through a communication channel (e.g., a radio channel), output the same to the controller 920, and transmit signals output from the controller 920 through the communication channel. The transceiver 910 may receive communication signals, output same to a processor, and transmit signals output from the processor to the UE, other base stations, or other network entities through a wired/wireless network.

The storage 930 may store programs and data necessary for operations of the base station. The storage 930 may store control information or data included in signals acquired by the base station. The storage 930 may include storage media such as a read only memory (ROM), a random access memory (RAM), a hard disk, a compact disc (CD)-ROM, and a digital versatile disc (DVD), or a combination of storage media. The storage 930 may store at least one of information transmitted/received through the transceiver 910 and information generated through the controller 920.

As used herein, the controller 920 may be defined as a circuit, an application specific integrated circuit, or at least one processor. The processor may include a communication processor (CP) which performs control for communication and an application processor (AP) which controls upper layers such as application programs. The controller 920 may control the overall operation of the base station according to the embodiments proposed in the disclosure. For example, the controller 920 may control signal flows between the respective blocks to perform operations according to the above-described flowcharts.

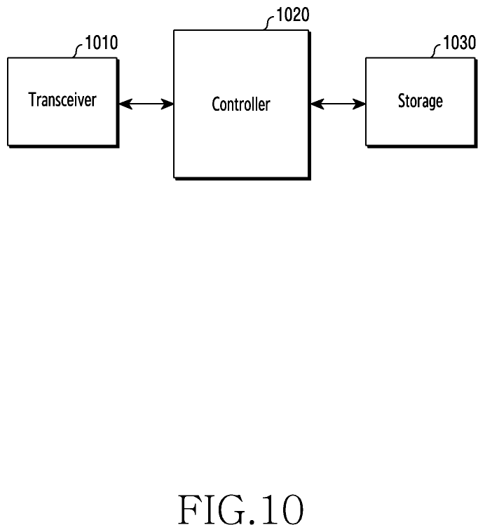

FIG. 10 illustrates a structure of a UE according to an embodiment.

Referring to FIG. 10, the UE may include a transceiver 1010, a controller 1020, and a storage 1030. The transceiver 1010, the controller 1020, and the storage 1030 may be operated according to the above-described communication methods of the UE. Components of the UE are not limited to the above-described example. For example, the UE may include a larger or smaller number of components than the above-described components. For example, the UE may include the transceiver 1010 and the controller 1020. Furthermore, the transceiver 1010, the controller 1020, and the storage 1030 may be implemented in the form of a single chip.

The transceiver 1010 refers to a UE receiver and a UE transmitter as a whole, and may transmit/receive signals with the base station, other UEs, and other network entities. The signals transmitted/received with the base station may include control information and data. The transceiver 1010 may receive, for example, system information, synchronization signals, or reference signals from the base station. To this end, the transceiver 1010 may include an RF transmitter configured to up-convert and amplify the frequency of transmitted signals, an RF receiver configured to low-noise-amplify received signals and down-convert the frequency thereof, and the like. However, the components of the transceiver 1010 are not limited to the RF transmitter and the RF receiver. The transceiver 1010 may include wired/wireless transceivers and various components for transmitting/receiving signals. The transceiver 1010 may receive signals through a radio channel, output the same to the controller 1020, and transmit signals output from the controller 1020 through the radio channel. The transceiver 1010 may receive communication signals, output same to a processor, and transmit signals output from the processor to a network entity through a wired/wireless network.

The storage 1030 may store programs and data necessary for operations of the UE. The storage 1030 may store control information or data included in signals acquired by the UE. The storage 1030 may include storage media such as a ROM, a RAM, a hard disk, a CD-ROM, and a DVD, or a combination of storage media.

As used herein, the controller 1020 may be defined as a circuit, an application specific integrated circuit, or at least one processor. The processor may include a CP which performs control for communication and an AP which controls upper layers such as application programs. The controller 1020 may control the overall operation of the UE according to the embodiments proposed in the disclosure. For example, the controller 1020 may control signal flows between the respective blocks to perform operations according to the above-described flowcharts.

Methods in the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to embodiments of the disclosure.

These programs (software modules or software) may be stored in non-volatile memories including a random access memory and a flash memory, a ROM, an electrically erasable programmable read only memory (EEPROM), a magnetic disc storage device, a CD-ROM, DVDs, or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), Wide LAN (WLAN), and storage area network (SAN) or a combination thereof. Such a storage device may access the electronic device via an external port. Also, a separate storage device on the communication network may access a portable electronic device.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the unit may perform certain functions. However, the unit does not always have a meaning limited to software or hardware. The unit may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units may be implemented to reproduce one or more CPUs within a device or a security multimedia card. The unit in the embodiments may include one or more processors.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a user equipment (UE) in a wireless communication system, the method comprising:
receiving, from a base station (BS), configuration information associated with a wake-up signal (WUS);
monitoring the WUS based on the configuration information;
in case that the WUS is received from the BS, determining whether the detected WUS triggers activation of a main radio (MR); and
determining whether to transmit an uplink signal based on whether the detected WUS triggers the activation of the MR.

2. The method of claim 1,
wherein, in case that the MR is in an inactive state and the WUS triggers the activation of the MR, the uplink signal is transmitted, and
wherein, in case that the MR is in the inactive state and the WUS does not trigger the activation of the MR, the uplink signal is not transmitted.

3. The method of claim 1,
wherein, in case that the MR is in an active state, the uplink signal is transmitted.

4. The method of claim 1,
wherein, in case that the WUS is not received by a wake-up receiver (WUR), the uplink signal is not transmitted.

5. The method of claim 1,
wherein the configuration information further includes information on an active time of the MR associated with a discontinuous reception (DRX).

6. A method performed by a base station (BS) in a wireless communication system, the method comprising:
transmitting, to a user equipment (UE), configuration information associated with a wake-up signal (WUS); and
transmitting, to the UE, the WUS,
wherein whether an uplink signal is received from the UE is identified based on whether the WUS triggers activation of a main radio (MR).

7. The method of claim 6,
wherein, in case that the MR is in an inactive state and the WUS triggers the activation of the MR, the uplink signal is received, and
wherein, in case that the MR is in the inactive state and the WUS does not trigger the activation of the MR, the uplink signal is not received.

8. The method of claim 6,
wherein, in case that the MR in an active state, the uplink signal is received.

9. The method of claim 6,
wherein, in case that the WUS is not received by a wake-up receiver (WUR), the uplink signal is not received.

10. The method of claim 6,
wherein the configuration information further includes information on an active time of the MR associated with a discontinuous reception (DRX).

11. A user equipment (UE) in a wireless communication system, the terminal comprising:
a transceiver; and
a controller coupled with the transceiver and configured to:
receive, from a base station (BS), configuration information associated with a wake-up signal (WUS);
monitor the WUS based on the configuration information;
in case that the WUS is received from the BS, identify whether the detected WUS triggers activation of a main radio (MR); and
identify whether to transmit an uplink signal based on the identification.

12. The UE of claim 11,
wherein, in case that the MR is in an inactive state and the WUS triggers the activation of the MR, the uplink signal is transmitted, and
wherein, in case that the MR is in the inactive state and the WUS does not trigger the activation of the MR, the uplink signal is not transmitted.

13. The UE of claim 11,
wherein, in case that the MR is in an active state, the uplink signal is transmitted.

14. The UE of claim 11,
wherein, in case that the WUS is not received by a wake-up receiver (WUR), the uplink signal is not transmitted.

15. The UE of claim 11,
wherein the configuration information further includes information on active time of the MR associated with a discontinuous reception (DRX).

16. A base station (BS) in a wireless communication system, the base station comprising:
a transceiver; and
a controller coupled with the transceiver and configured to:
transmit, to a user equipment (UE), configuration information associated with a wake-up signal (WUS); and
transmit, to the UE, the WUS,
wherein whether an uplink signal is received from the UE is identified based on whether the WUS triggers activation of a main radio (MR).

17. The BS of claim 16,
wherein, in case that the MR is in an inactive state and the WUS triggers the activation of the MR, the uplink signal is received,
wherein, in case that the MR is in the inactive state and the WUS does not trigger the activation of the MR, the uplink signal is not received.

18. The BS of claim 16,
wherein, in case that the MR is in an active stat, the uplink signal is received.

19. The BS of claim 16,
wherein, in case that the WUS is not received by a wake-up receiver (WUR), the uplink signal is not received.

20. The BS of claim 16,
wherein the configuration information further includes information on an active time of the MR associated with a discontinuous reception (DRX).
